(19) United States
(12) Patent Application Publication
(10) Pub. No.: US 2014/0086542 A1
(43) Pub. Date: Mar. 27, 2014

(54) Transport Vehicle Wiring Harness Extension Using Physical Layer Device Point-To-Point Repeaters

(71) Applicant: BROADCOM CORPORATION, Irvine, CA (US)

(72) Inventor: Wael William Diab, San Francisco, CA (US)

(73) Assignee: Broadcom Corporation, Irvine, CA (US)

(21) Appl. No.: 13/625,020

(22) Filed: Sep. 24, 2012

(51) Int. Cl. H01B 11/22; H02G 3/00; G02B 6/44

(52) U.S. Cl. 385/101; 385/100; 307/9.1; 307/10.1

(57) ABSTRACT

A transport vehicle wiring harness extension using physical layer device point-to-point repeaters. In one embodiment, a transport vehicle network including a first network node and a second network node can be enabled using a cable harness that includes a point-to-point extender device that couples a first network cable to a second network cable.

BACKGROUND

1. Field of the Invention

The present invention relates generally to transport vehicle networks and, more particularly, to a transport vehicle wiring harness extension using physical layer device point-to-point repeaters.

2. Introduction

Transport vehicles such as automobiles, trucks, buses, boats, airplanes, etc. have begun to incorporate increasing amounts of network technology. Automobiles, for example, are becoming increasingly reliant on computer networks in their control of automotive functions and their interaction with users. User-oriented displays, for example, are becoming increasingly common in their presentation of navigation, infotainment, and vehicle control user interfaces.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example of an extended point-to-point link using point-to-point repeaters.

FIG. 2 illustrates an embodiment of a logical link between two network nodes.

FIG. 3 illustrates an embodiment of a point-to-point repeater.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Communication within a transport vehicle such as automobiles, trucks, buses, boats, airplanes, etc. is enabled via a wiring harness. Unlike structured cabling systems within a data center that have a well-defined channel structure, a wiring harness within a transport vehicle can vary significantly between vehicle manufacturers, transport vehicle models, and vehicle options selected. Numerous constraints exist for such networking applications as issues of emissions, weight, etc. can lead to a dynamic environment with respect to cabling requirements. In one example, weight considerations have lead to the inclusion of reduced twisted pair copper cables that are defined for transport vehicle applications.

In an environment where cabling standards are difficult to define for cable lengths, cable types, maximum number of connectors, etc., the need for flexibility in the options available to wiring transport vehicles becomes significant. For example, some vehicle designs may require a large number of connectors, which can limit the reach of the data transmission system over such a link, while other vehicle designs may require additional cable lengths due to the increased physical dimensions of a particular vehicle (e.g., wiring a bus vs. wiring a car).

In one embodiment, a transport vehicle network including a first network node and a second network node can be enabled using a cable harness that enables a point-to-point connection between the first network node and the network second node, wherein the cable harness includes a first network cable that is coupled to the first network node and a second network cable that is coupled to the second network cable. Included as part of the cable harness is a point-to-point extender device that couples the first network cable to the second network cable, thereby enabling a point-to-point connection between the first network node and the second network node. In one embodiment, the extender device includes a first physical layer device that is coupled to the first network cable and a second physical layer device that is coupled to the second network cable, such that a first physical link formed between the first network node and the first physical layer device and a second physical link formed between the second network node and the second physical layer device form a single logical link between the first network node and the second network node.

In promoting increased flexibility in the wiring harness, the extender device can be designed to interface with two network cables having different cabling specifications. The two network cables can have different specification for the same cabling type (e.g., copper, twisted pair, optical, etc.) or can have different cabling types. For example, the extender device can be designed to couple a twisted pair copper cable with an optical cable. In another example, the extender device can be designed to couple a one-pair twisted pair copper cable with a two-pair twisted pair copper cable.

In one embodiment, the extender device can also be configured to interface two physical layer devices that operate at different link rates. In this embodiment, the extender device can be designed to perform a rate conversion between the two physical layer devices. In one example, a buffer can be included within the extender device to facilitate the rate conversion functionality of the extender device.

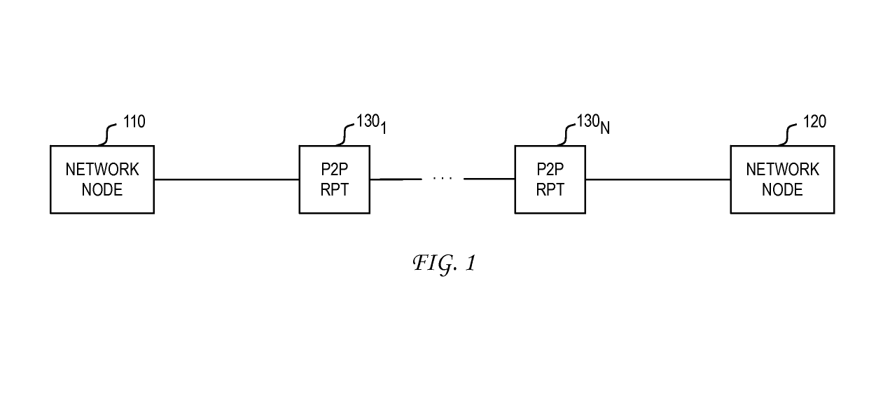

FIG. 1 illustrates an example of an extended point-to-point link using point-to-point repeaters. As illustrated, network node 110 is coupled to network node 120 via one or more point-to-point repeaters 130ₙ. Each of the point-to-point repeaters 130ₙ can be designed to extend a cable connection from network node 110 to network node 120. For example, a link between network node 110 and network node 120 can include a large number of inline connectors that limits the reach of the link, or the link may have an extended reach requirement due to the increased physical distance existing in one vehicle model as compared to another vehicle model. As would be appreciated, various application-specific scenarios can dictate that the specific link margins are compromised.

It is a feature of the present invention that a point-to-point repeaters can be used to provide increased flexibility in the wiring harness of a transport vehicle network to address unique requirements for a given transport vehicle link. In one embodiment, the point-to-point repeater can be designed to extend a network link having a first network cable with a second network cable having the same cabling specifications. For example, a link between a first network node and a second network node can be extended using a single point-to-point repeater. In this example, the single point-to-point repeater can be designed to interface two network cables having the same cabling specifications (e.g., same type of reduced twisted pair Ethernet cable).

In another embodiment, the point-to-point repeater can be designed to extend a network link that uses a first network cable with a second network cable having different cabling specifications. For example, where a link between a first network node and a second network node is extended using a single point-to-point repeater, the single point-to-point repeater can be designed to interface a first network cable having a first cabling specification and a second network cable having a second cabling specification. Here, the different specifications can be of the same cabling types (e.g., copper, twisted pair, optical, etc.) or can represent different cabling types altogether.

In yet another example, a pair of point-to-point repeaters can be used to extend a network link. In one scenario, the physical link between network node 110 and point-to-point repeater 130₁ and the physical link between network node 120 and point-to-point repeater 130_{N} have the same cabling specification. The physical link between point-to-point repeater 130₁ and point-to-point repeater 130_{N}, on the other hand, can have a different cabling specification. Here, for example, the cabling specification can be optimized for a particular use in performing a cable extension function. As would be appreciated, various extension applications can be envisioned using various cabling specifications between network nodes and point-to-point repeaters. Any number of point-to-point repeaters can be used in a given application as would be apparent.

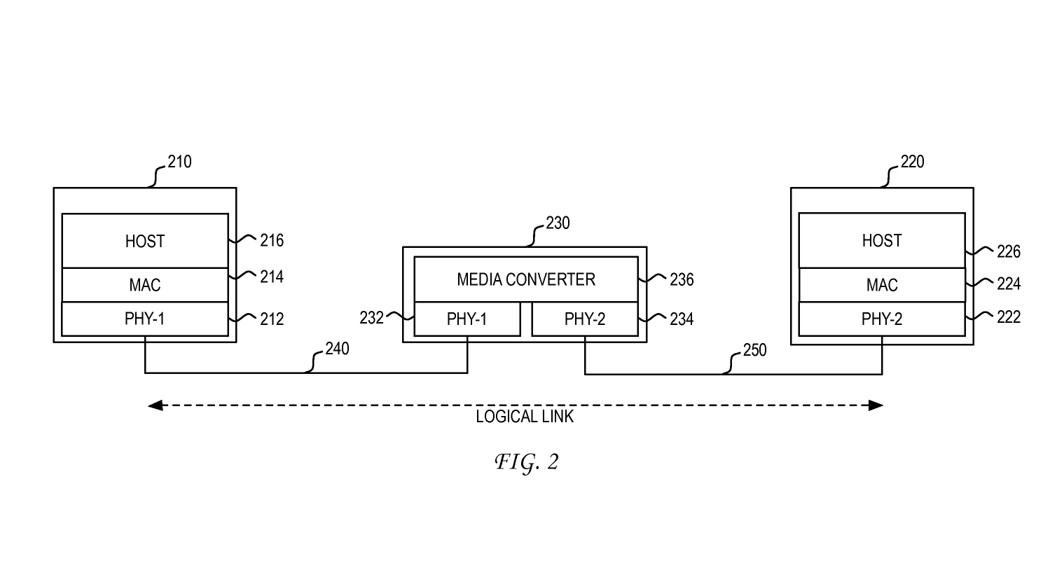

FIG. 2 illustrates an embodiment of a logical link between two network nodes, which illustrates a framework of the functionality provided by a point-to-point repeater. As illustrated, the logical link is created between network node 210 and network node 220. Each of network nodes 210 and 220 include a protocol stack as illustrated. Network node 210 includes a physical layer device (PHY) 212, media access control (MAC) layer 214, and host 216 having higher layer protocols. Similarly, network node 220 includes PHY 222, MAC 224, and host 226. The protocol stack enables network node 210 to communicate with network node 220 via a logical link that includes multiple physical link segments 240 and 250.

In general, hosts 216 and 226 may comprise suitable logic, circuitry, and/or code that may enable operability and/or functionality of the five highest functional layers for data packets that are to be transmitted over the link. Since each layer in the OSI model provides a service to the immediately higher interfacing layer, MACs 214 and 224 may provide the necessary services to hosts 216 and 226 to ensure that packets are suitably formatted and communicated to PHYs 212 and 222, respectively. MACs 214 and 224 may comprise suitable logic, circuitry, and/or code that may enable handling of data link layer (Layer 2) operability and/or functionality. MACs 214 and 224 can be configured to implement Ethernet protocols, such as those based on the IEEE 802.3 standard, for example. PHYs 212 and 222 can be configured to handle physical layer requirements, which include, but are not limited to, packetization, data transfer and serialization/deserialization (SERDES).

As noted, the logical link is based on physical link segments 240 and 250. Physical link segment 240 is based on a connection between PHY 212 in network node 210 and PHY 232 in point-to-point repeater 230, while physical link segment 250 is based on a connection between PHY 222 in network node 220 and PHY 234 in point-to-point repeater 230. As further illustrated, PHYs 212 and 232 are labeled of a type PHY-1, which is used to illustrate a PHY that is configured to communicate over a physical medium having a first specification. PHYs 222 and 234, on the other hand, are labeled of a type PHY-2, which is used to illustrate a PHY that is configured to communicate over a physical medium having a second specification different than the first specification. As illustrated, point-to-point repeater 230 has a limited protocol stack as compared to network nodes 210 and 220. Such a limited protocol stack is directed to the particular function described above of extending a link between two network nodes.

As PHYs 232 and 234 in point-to-point repeater 230 are designed to interface with physical media having different specifications, point-to-point repeater 230 can serve a media converter function. In facilitating such a media conversion function, point-to-point repeater can also include media converter module 236. In general, media converter module 236 is designed to address any mismatches that are created at the boundary between PHY-1 232 and PHY-2 234. In one example, media converter module 236 can be designed to address any variance in transmission rate between PHY-1 232 and PHY-2 234. In another example, media converter module 236 can be designed to address any variance in packetization between PHY-1 232 and PHY-2 234. In yet another example, media converter module 236 can be designed to facilitate time-sensitive protocols being run between network node 210 and network node 220. In one application, media converter module 230 can be designed to minimize or otherwise control latency incurred through point-to-point repeater 230 to facilitate a audio-video bridging (AVB) protocol that is running between network node 210 and network node 220 in delivering AV traffic in the transport vehicle network. As would be appreciated, the particular role performed by media converter module 236 would be dependent on the implementation differences between PHY-1 232 and PHY-2 234.

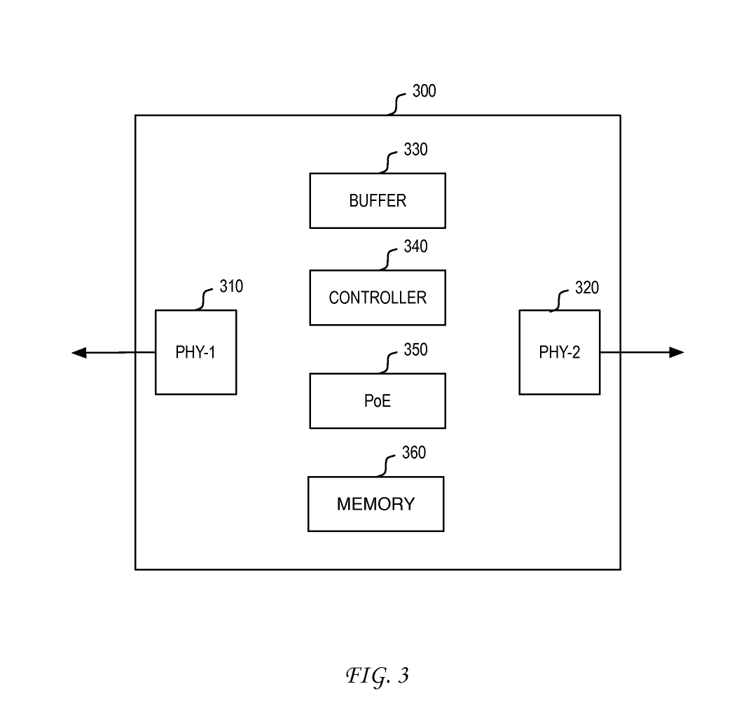

FIG. 3 illustrates an embodiment of a point-to-point repeater. As illustrated, point-to-point repeater 300 includes PHY 310 and PHY 320. PHYs 310 and 320 can be coupled to a network node or to another point-to-point repeater. Regardless, PHY 310 is designed to interface with a physical medium having a first specification, while PHY 320 is designed to interface with a physical medium having a second specification different from a first specification. In coupling traffic that is transmitted between PHY-1 310 and PHY-2 320, point-to-point repeater 300 includes buffer 330. Buffer 330 can include an upstream and downstream buffers that are designed to hold traffic flowing in both directions between PHY-1 310 and PHY-2 320. As noted above, PHY-1 310 and PHY-2 320 may use the same link rate, or may use different link rates. Where different link rates are used by PHY-1 310 and PHY-2 320, controller 340 can be designed to perform a rate adaptation between PHY-1 310 and PHY-2 320 based, for example, on control signals generated by monitored levels in buffer 330.

In general, controller 340 can be configured to minimize or otherwise control the latency introduced by point-to-point repeater 300. Here, the control of the variation of the latency that is introduced by one or more point-to-point repeaters 300 can be beneficial to the efforts by the network nodes in accounting for end-to-end latency in the logical link. It should also be noted that the use of a limited protocol stack in the point-to-point repeater serves to reduce the latency as compared to more complex repeater devices that provide additional management functionality. In one embodiment, the point-to-point repeater can be designed to be invisible to the upper layer protocols used at the network nodes that define the logical link.

As further illustrated in FIG. 3, point-to-point repeater 300 also includes power over Ethernet (PoE) module 350 that enables point-to-point repeater 300 to operate as a powered device (PD) that receives power from a power sourcing equipment (PSE) network node in the same cabling used for data communication. Such an inline powering mechanism enables point-to-point repeater 300 to be embodied as an extremely small device that can be embedded into the wiring harness and/or connectors in an unobtrusive manner. In one embodiment, PoE module 350 contains the electronics that would enable the PD to communicate with a PSE in accordance with IEEE 802.3af, 802.3at, legacy PoE transmission, or any other type of PoE transmission. The PD can also include a controller (e.g., pulse width modulation DC:DC controller) that controls a power transistor (e.g., field effect transistor (FET)), which in turn provides constant power to a load.

Point-to-point repeater 300 can also include memory 360. In general, memory 360 enables point-to-point repeater 300 to store control packets or other management information that enables point-to-point repeater 300 to enter a low power state. In one embodiment, the low power state can be used by point-to-point repeater 300 in response to a network node's decision to have the logical link enter into a low power sleep state.

In one embodiment, point-to-point repeater 300 can also have an embedded switching/packet processing function that can perform processing on the packets. In one example, point-to-point repeater 300 can include a three-port switch having two external ports and one internal port for processing/injecting packets. In one embodiment, point-to-point repeater can have MACSec capability.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

what is claimed is:

1. A transport vehicle network, comprising:
a first network node;
a second network node;
a cable harness in a transport vehicle that enables a point-to-point connection between said first network node and said network second node, said cable harness including a first network cable that is coupled to said first network node and a second network cable that is coupled to said second network cable, said first network cable being coupled to said second network cable via an extender device that provides said point-to-point connection between said first network node and said second network node, said extender device including a first physical layer device that is coupled to said first network cable and a second physical layer device that is coupled to said second network cable, wherein a first physical link formed between said first network node and said first physical layer device and a second physical link formed between said second network node and said second physical layer device form a single logical link between said first network node and said second network node.

2. The transport vehicle network of claim 1, wherein said first network cable is a reduced twisted pair cable having only one or two twisted cable pairs.

3. The transport vehicle network of claim 1, wherein said first network cable and said second network cable have the same cable specifications.

4. The transport vehicle network of claim 1, wherein said first network cable and said second network cable have different cable specifications.

5. The transport vehicle network of claim 4, wherein said first network cable and said second network cable have the same cable type, said cable type being chosen from one of copper, twisted pair and optical cable types.

6. The transport vehicle network of claim 4, wherein said first network cable and said second network cable have different cable types, said first network cable and said second network cable being chosen from one of copper, twisted pair and optical cable types.

7. The transport vehicle network of claim 1, wherein said extender device is powered from said first network node via said first network cable.

8. The transport vehicle network of claim 1, wherein said extender device further includes a rate converter module that enables operation of said first physical layer device to operate at a rate that is different from said second physical layer device.

9. The transport vehicle network of claim 1, wherein said first network node and said second network node compensate for a single latency delay that extends across said first and second network cable.

10. The transport vehicle network of claim 1, wherein said extender device does not contain additional physical layer devices beyond said first and second physical layer devices.

11. The transport vehicle network of claim 1, wherein said transport vehicle is an automotive vehicle.

12. The transport vehicle network of claim 1, wherein said transport vehicle is an aircraft vehicle.

13. An extender device, comprising:
a first physical layer device that is configured for coupling to a first network node in a transport vehicle network via a first network cable of a first media type; and
a second physical layer device that is configured for coupling to a second network node in said transport vehicle network via a second network cable of a second media type different from said first media type, wherein said extender device extends a point-to-point logical link connection between said first network node and said second network node.

14. The extender device of claim 13, wherein said first physical layer device is configured to communicate with said first network node via a copper twisted pair cable and said second physical layer device is configured to communicate with said second network node via an optical cable.

15. The extender device of claim 13, wherein said extender device is configured to receive power via one of said first and second network cables.

16. The extender device of claim 13, further comprising a rate converter module that enables operation of said first physical layer device to operate at a rate that is different from said second physical layer device.

17. The transport vehicle network of claim 1, wherein said transport vehicle is an automotive vehicle.

18. The transport vehicle network of claim 1, wherein said transport vehicle is an aircraft vehicle.
